(19) United States
(12) Patent Application Publication
(10) Pub. No.: US 2020/0053415 A1
(43) Pub. Date: Feb. 13, 2020

(54) SYSTEMS AND METHODS FOR AGGREGATING MEDIA CONTENT OFFERINGS

(71) Applicant: Telefonaktiebolaget LM Ericsson (publ), Stockholm (SE)

(72) Inventor: Stefan Paul Redmond, Pointe-Claire (CA)

(21) Appl. No.: 16/331,626

(22) PCT Filed: Sep. 8, 2016
(86) PCT No.: PCT/IB2016/055352

§ 371 Date: Mar. 8, 2019

(51) Int. Cl. H04N 21/431; H04N 21/45; H04N 21/482; H04N 21/4627

(52) U.S. Cl. CPC H04N 21/4312; H04N 21/4627; H04N 21/4826; H04N 21/4532

(57) ABSTRACT

Systems and methods relating to aggregating content offerings are disclosed. In some embodiments, a method of operation of a computing node comprises generating a user-specific content catalog comprising content offerings for a plurality of content items from two or more service providers to which a respective user has access. For each content item, the content offerings comprise at least one content offering for the content item from at least one of the two or more service providers. The method further comprises, for a content item, identifying a best content offering from among the at least one content offering for the content item in accordance with one or more content consumption preferences associated with the respective user. The best content offering is a content offering from among the at least one content offering for the content item that most closely satisfies the one or more content consumption preferences.

### TECHNICAL FIELD

The present disclosure relates to media content and, in particular, aggregating media content offerings from multiple service providers.

### BACKGROUND

In recent years, the amount of media content available to end users has increased drastically both in terms of the range of the media content available and the range of service providers from which the content is available. For example, a particular end-user may have access to media content from his or her Television (TV) service provider, one or more subscription-based service providers (e.g., Netflix, Hulu Plus, Amazon Prime Video, HBO GO, etc.), and one or more service providers that enable purchase and/or rental of media content (e.g., Apple iTunes Store, Amazon, etc.). Although this gives the end-user far greater choice, it also presents a user interface problem in that it may be very difficult for an end-user to choose or locate content of interest.

There are existing solutions (e.g., universal search on AppleTV) that allow matching content from multiple providers to be displayed in a unified search result. However, the existing solutions are still less than ideal.

### SUMMARY

Systems and methods relating to aggregating content offerings are disclosed. In some embodiments, a method of operation of a computing node comprises generating a user-specific content catalog comprising content offerings for a plurality of content items from two or more service providers to which a respective user has access. For each content item of the plurality of content items, the content offerings comprise at least one content offering for the content item from at least one of the two or more service providers. The method further comprises, for a content item of the plurality of content items, identifying a best content offering from among the at least one content offering for the content item in accordance with one or more content consumption preferences associated with the respective user. The best content offering is a content offering from among the at least one content offering for the content item that most closely satisfies the one or more content consumption preferences associated with the respective user.

In some embodiments, the content offerings comprise multiple content offerings for a same content item, the multiple content offerings being from multiple respective service providers.

In some embodiments, identifying the best content offering from among the at least one content offering for the content item in accordance with the one or more content consumption preferences associated with the respective user comprises pre-emptively identifying the best content offering from among the at least one content offering for the content item. In some embodiments, the method further comprises, for each additional content item of the plurality of content items in the user-specific content catalog, pre-emptively identifying a best content offering from among the at least one content offering for the additional content item in accordance with the one or more content consumption preferences associated with the respective user. The best content offering is a content offering from among the at least one content offering for the additional content item that most closely satisfies the one or more content consumption preferences associated with the respective user.

In some embodiments, pre-emptively identifying the best content offering from among the at least one content offering for the content item comprises pre-emptively identifying the best content offering from among the at least one content offering for the content item based on the one or more content consumption preferences associated with the respective user and content consumption rights previously obtained for the at least one offering for the content item. In some embodiments, the method further comprises, prior to generating the user-specific content catalog, receiving the at least one content offering from the respective service provider where the at least one content offering comprises the content consumption rights for the at least one content offering for the content item. In some other embodiments, the method further comprises, prior to generating the user-specific content catalog, actively negotiating the content consumption rights for the at least one content offering for the content item with at least one respective service provider.

In some embodiments, pre-emptively identifying the best content offering from among the at least one content offering for the content item comprises pre-emptively identifying the best content offering from among the at least one content offering for the content item based on the one or more content consumption preferences associated with the respective user and content consumption rights obtained for the content item in an active manner. Further, in some embodiments, pre-emptively identifying the best content offering from among the at least one content offering for the content item based on the one or more content consumption preferences associated with the respective user and the content consumption rights obtained for the content item in an active manner comprises: actively negotiating the content consumption rights for the at least one content offering for the content item with at least one respective service provider after generating the user-specific content catalog and identifying the best content offering from among the at least one content offering for the content item based on the one or more content consumption preferences associated with the respective user and the content consumption rights actively negotiated for the at least one content offering for the content item.

In some embodiments, the method further comprises receiving a content item selection from a user device of the respective user, the content item selection being a selection of the content item for which the best content offering was pre-emptively identified. The method further comprises providing the best content offering identified for the content item to the user device. In some embodiments, the method further comprises receiving a request for the best content offering of the content item and, upon receiving the request, effecting delivery of the content item from the respective service provider associated with the best content offering.

In some embodiments, the method further comprises receiving a content item selection, the content item selection being a selection of one of the plurality of content items in the user-specific content catalog. Further, identifying the best content offering from among the at least one content offering for the content item in accordance with the one or more content consumption preferences associated with the respective user comprises reactively identifying the best content offering from among the at least one content offering for the content item selected by the content item selection upon receiving the content item selection.

In some embodiments, reactively identifying the best content offering from among the at least one content offering for the content item comprises reactively identifying the best content offering from among the at least one content offering for the content item based on the one or more content consumption preferences associated with the respective user and content consumption rights previously obtained for the at least one offering for the content item. In some embodiments, the method further comprises, prior to generating the user-specific content catalog, receiving the at least one content offering from the respective service provider, the at least one content offering comprising the content consumption rights for the at least one content offering for the content item. In some other embodiments, the method further comprises, prior to generating the user-specific content catalog, actively negotiating the content item with at least one respective service provider.

In some embodiments, reactively identifying the best content offering from among the at least one content offering for the content item comprises reactively identifying the best content offering from among the at least one content offering for the content item based on the one or more content consumption preferences associated with the respective user and content consumption rights obtained for the content item in an active manner.

In some embodiments, reactively identifying the best content offering from among the at least one content offering for the content item based on the one or more content consumption preferences associated with the respective user and the content consumption rights obtained for the content item in an active manner comprises: actively negotiating the content consumption rights for the at least one content offering for the content item selected by the content item selection with at least one respective service provider upon receiving the content item selection and identifying the best content offering from among the at least one content offering for the content item selected by the content item selection based on the one or more content consumption preferences associated with the respective user and the content consumption rights actively negotiated for the at least one content offering for the content item selected by the content item selection.

In some embodiments, the method further comprises providing the best content offering identified for the content item to a user device of the respective user. In some embodiments, the method further comprises receiving a request for the best content offering of the content item and, upon receiving the request, effecting delivery of the content item from the respective service provider associated with the best content offering.

In some embodiments, identifying the best content offering from among the at least one content offering for the content item further comprises identifying the best content offering from among the at least one content offering for the content item in accordance with the one or more content consumption preferences associated with the respective user and subscription rights of the respective user.

In some embodiments, the one or more content consumption preferences associated with the respective user comprise a maximum purchase price, a maximum rental price, a minimum playback quality, a minimum rental duration, a preference related to portability, a preferred delivery method, a preference regarding immediately availability, a preference for presence or absence of advertisements or commercials, and/or a preference for a density of advertisements or commercials.

In some embodiments, at least one of the two or more service providers is a subscription-based service provider, and the respective user is a subscriber of the at least one of the two or more service providers.

In some embodiments, at least one of the two or more service providers is a subscription-based service provider, and the respective user is a guest of the at least one of the two or more service providers.

In some embodiments, at least one of the two or more service providers is a non-subscription-based service provider.

Embodiments of a computing node are also disclosed. In some embodiments, a computing node is adapted to generate a user-specific content catalog comprising content offerings for a plurality of content items from two or more service providers to which a respective user has access. For each content item of the plurality of content items, the content offerings comprise at least one content offering for the content item from at least one of the two or more service providers. The computing node is further adapted to, for a content item of the plurality of content items, identify a best content offering from among the at least one content offering for the content item in accordance with one or more content consumption preferences associated with the respective user. The best content offering is a content offering from among the at least one content offering for the content item that most closely satisfies the one or more content consumption preferences associated with the respective user.

In some embodiments, the computing node is further adapted to perform the method of operation of a computing node according to any of the embodiments disclosed herein.

In some embodiments, a computing node comprises at least one communication interface, at least one processor, and memory comprising instructions executable by the at least one processor whereby the computing node is operable to: (a) generate a user-specific content catalog comprising content offerings for a plurality of content items from two or more service providers to which a respective user has access, wherein, for each content item of the plurality of content items, the content offerings comprise at least one content offering for the content item from at least one of the two or more service providers and (b) for a content item of the plurality of content items, identify a best content offering from among the at least one content offering for the content item in accordance with one or more content consumption preferences associated with the respective user, the best content offering being a content offering from among the at least one content offering for the content item that most closely satisfies the one or more content consumption preferences associated with the respective user.

In some embodiments, a computing node comprises a generating module and an identifying module. The generating module is operable to generate a user-specific content catalog comprising content offerings for a plurality of content items from two or more service providers to which a respective user has access. For each content item of the plurality of content items, the content offerings comprise at least one content offering for the content item from at least one of the two or more service providers. The identifying module is operable to, for a content item of the plurality of content items, identify a best content offering from among the at least one content offering for the content item in accordance with one or more content consumption preferences associated with the respective user. The best content offering being a content offering from among the at least one content offering for the content item that most closely satisfies the one or more content consumption preferences associated with the respective user.

Embodiments of a method of operation of a user device are also disclosed. In some embodiments, a method of operation of a user device comprises providing a content item selection to an aggregation system and receiving a best content offering for a content item indicated by the content item selection. The best content offering is a content offering from among at least one content offering for the content item that is available to a respective user of the user device from two or more service providers that most closely satisfies one or more content consumption preferences associated with the respective user of the user device. The method further comprises providing a request for the best content offering to the aggregation system and receiving the content item in accordance with the best content offering.

In some embodiments, the method further comprises providing the one or more content consumption preferences to the aggregation system.

In some embodiments, the method further comprises providing subscription information for the respective user to the aggregation system, the subscription information comprising information that is indicative of subscription rights of the respective user to one or more subscription-based service providers.

In some embodiments, the best content offering from among the at least one content offering for the content item is further based on the subscription rights of the respective user.

In some embodiments, the one or more content consumption preferences associated with the respective user comprise a maximum purchase price, a maximum rental price, a minimum playback quality, a minimum rental duration, a preference related to portability, a preferred delivery method, a preference regarding immediately availability, a preference for presence or absence of advertisements or commercials, and/or a preference for a density of advertisements or commercials.

In some embodiments, at least one of the two or more service providers is a subscription-based service provider, and the respective user is a subscriber of the at least one of the two or more service providers.

In some embodiments, at least one of the two or more service providers is a subscription-based service provider, and the respective user is a guest of the at least one of the two or more service providers.

In some embodiments, at least one of the two or more service providers is a non-subscription-based service provider.

Embodiments of a user device are also disclosed. In some embodiments, a user device is adapted to provide a content item selection to an aggregation system and receive a best content offering for a content item indicated by the content item selection. The best content offering is a content offering from among at least one content offering for the content item that is available to a respective user of the user device from two or more service providers that most closely satisfies one or more content consumption preferences associated with the respective user of the user device. The user device is further adapted to provide a request for the best content offering to the aggregation system and receive the content item in accordance with the best content offering.

In some embodiments, the user device is further adapted to operate according to any of the embodiments of the method of operation of a user device disclosed herein.

In some embodiments, a user device comprises at least one communication interface, at least one processor, and memory comprising instructions executable by the at least one processor whereby the user device is operable to: provide a content item selection to an aggregation system; receive a best content offering for a content item indicated by the content item selection, the best content offering being a content offering from among at least one content offering for the content item that is available to a respective user of the user device from two or more service providers that most closely satisfies one or more content consumption preferences associated with the respective user of the user device; provide a request for the best content offering to the aggregation system; and receive the content item in accordance with the best content offering.

In some embodiments, a user device comprises a providing module, a best content offering receiving module, a requesting module, and a content item receiving module. The providing module is operable to provide a content item selection to an aggregation system. The best content offering receiving module is operable to receive a best content offering for a content item indicated by the content item selection. The best content offering is a content offering from among at least one content offering for the content item that is available to a respective user of the user device from two or more service providers that most closely satisfies one or more content consumption preferences associated with the respective user of the user device. The requesting module is operable to provide a request for the best content offering to the aggregation system. The content item receiving module is operable to receive the content item in accordance with the best content offering.

Those skilled in the art will appreciate the scope of the present disclosure and realize additional aspects thereof after reading the following detailed description of the embodiments in association with the accompanying drawing figures.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a system in which embodiments of the present disclosure may be implemented;

FIG. 2 is a more detailed illustration of the system of FIG. 1 with respect to a single user device according to some embodiments of the present disclosure;

FIGS. 3A and 3B illustrate the operation of the system of FIGS. 1 and 2 according to various embodiments of the present disclosure;

FIG. 4 illustrates the system of FIGS. 1 and 2, but further illustrates various services, or interfaces, between the various components to enable aspects of some embodiments of the present disclosure;

FIG. 5 illustrates an alternative embodiment of the system in which the aggregation system is implemented between the service providers;

FIGS. 6 and 7 illustrate example embodiments of a processing node; and

FIGS. 8 and 9 illustrate example embodiments of a user device.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Content Item: As used herein, a “content item” or “media content item” is an individual media content product, e.g., an episode of a Television (TV) series, a movie, a documentary, a Pay-Per-View (PPV) event, a song, a music album, an audio book, or the like.

Content Offering: As used herein, a “content offering” or “media content offering” is an offer for a content item by a respective service provider. The content offering includes consumption rights (i.e., terms).

Consumption Rights: As used herein, “consumption rights” for a content offering define the terms under which the respective content item is being offered by the respective service provider for consumption by the end-user. The consumption rights may include, e.g.
purchase price,
rental price,
subscription or rental terms (e.g., rental duration),
usage conditions such as, e.g.
   device class (e.g., set-top box, iOS), Android, etc.),
   network access (managed or unmanaged),
   delivery methods (e.g., Direct-to-Home (DTH), Over-the-Top (OTT), Wi-Fi, cellular), and/or
   geographical location such as, e.g., allowed or disallowed geographical locations, and/or
how or if the respective content item is sponsored (i.e., applicability of ad placement, ad selection, ad frequency and density, etc.).

Content Provider: As used herein, a “content provider” is an entity that produces or originally produces and/or distributes a content item. A content provider is always the sole provider of a particular content item. Example content providers include TV production companies (e.g., NBC, ABC, CBS, Fox, HBO, etc.), movie production companies (e.g., Sony Pictures, Dreamworks, or the like), Internet-based content production companies (e.g., Netflix for Netflix original content items, Amazon for Amazon original content items), etc.

Content Provider System: As used herein, a “content provider system” is system (e.g., a server computer, a network of server computers, and/or other content delivery devices) through which a content provider provides content.

Service Provider: As used herein, a “service provider” is an entity that provides a service through which end-users are enabled to consume media content items (i.e., a service that delivers content). Example service providers are TV service providers (e.g., Comcast, Time Warner, etc.), Internet-based service providers (e.g., Apple, Amazon, Netflix, Hulu, HBO via HBO GO, CBS via CBS All Access, etc.). Service providers create content offerings which can be in the form of, e.g., subscription Video On Demand (VoD), rental VoD, purchase VoD, free VoD, PPV linear, subscription linear, free linear, or the like.

Service Provider System: As used herein, a “service provider system” is a system (e.g., a server computer, a network of server computers, and/or other content delivery devices) through which a service provider provides a content delivery service (e.g., a broadcast or on-demand TV service, a streaming media content service, a media content purchase or rental service, or the like).

In recent years, the amount of media content available to end-users has increased drastically both in terms of the range of the media content available and the range of service providers from which the content is available. This has given the end-user far greater choice. However, the result is that there is a user interface problem in that it may be very difficult for an end-user to choose or locate content of interest. Still further, when an end-user has multiple content offerings for a particular content item of interest from multiple service providers, it can be very difficult for the end-user to locate the best content offering in terms of price and/or other preferences.

There are existing solutions (e.g., universal search on AppleTV) that allow matching content from multiple providers to be displayed in a unified search result. However, the existing solutions still do not enable the end-user to locate the best content offering for a content item of interest.

In this regard, systems and methods are disclosed herein for aggregating content offerings from multiple service providers to provide a user-specific content catalog for an end-user. Still further, in some embodiments, the best content offering for each content item in the user-specific content catalog is identified pre-emptively taking into consideration one or more offering acceptance preferences of the end-user and content consumption rights for the content offerings. Thereafter, when the end-user selects a content item, the end-user is presented with the best content offering for that content item. In some other embodiments, taking into consideration one or more offering acceptance preferences of the end-user and content consumption rights, a best content offering for a select content item in the user-specific content catalog is identified reactively upon selection by the user. In either the preemptive or reactive embodiments, the content consumption rights associated with a content offering may be obtained passively or actively (e.g., through active negotiations with the respective service providers).

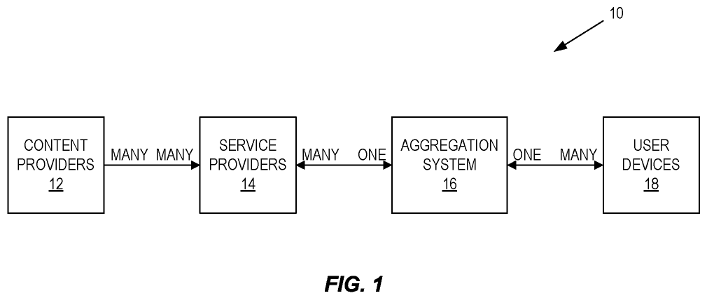

In this regard, FIG. 1 illustrates a system 10 in which embodiments of the present disclosure may be implemented. As illustrated, the system 10 includes a number of content providers 12, a number of service providers 14, an aggregation system 16, and user devices 18 associated with respective end-users, or consumers. The content providers 12 are the sources of content items such as, e.g., movies, episodes of TV series, etc. The service providers 14 offer services through which content offerings are provided to end-users associated with the user device 18 for the content items provided by the content providers 12. The services may be subscription-based or free services. As used herein, a subscription-based service is either a fee-based or free service, e.g., requiring user credentials (e.g., a username and password) for accessing the service. Further, the services may be purchase based or rental based services.

The aggregation system 16 operates to aggregate the content offerings from the multiple service providers 14 to provide user-specific content catalogs for the end-users. Still further, at least some of the content items may have multiple respective content offerings from multiple service providers 14. Thus, the aggregation system 16 operates to identify a “best” content offering for each content item in the user-specific content catalog (preemptive identification) or for a select content item in the user-specific content catalog (reactive identification). As used herein, a “best” content offering is the content offering for the respective content item having associated content consumption rights that most closely satisfy one or more offering acceptance preferences of the end-user. As discussed below, in some embodiments, the aggregation system 16 passively obtains the content consumption rights. In other embodiments, the aggregation system 16 actively negotiates the content consumption rights to obtain the best possible “deal” for the end-user (e.g., lowest price).

The aggregation system 16 may be implemented as hardware or a combination of hardware and software. For example, in some embodiments, the aggregation system 16 is implemented on a server computer(s) or “in the cloud” in which case the functionality of the aggregation system 16 is implemented as software that is executed by a processor(s) (e.g., Central Processing Unit(s) (CPU(s))) of the server computer(s) or by one or more processing nodes “in the cloud.” The user devices 18 may include client applications that provide an appropriate interface to the aggregation system 16. As another example, even though illustrated separately, in some embodiments, the aggregation system 16 is implemented in the user devices 18 (e.g., the functionality of the aggregation system 16 may be implemented as software that is executed by a processor(s) of the user device 18).

The user devices 18 are any devices on which or through which an end-user can consume content items. For example, the user devices 18 may include set-top boxes, smart TVs, Blu-ray players, personal computers, tablet computers, smart phones, or the like.

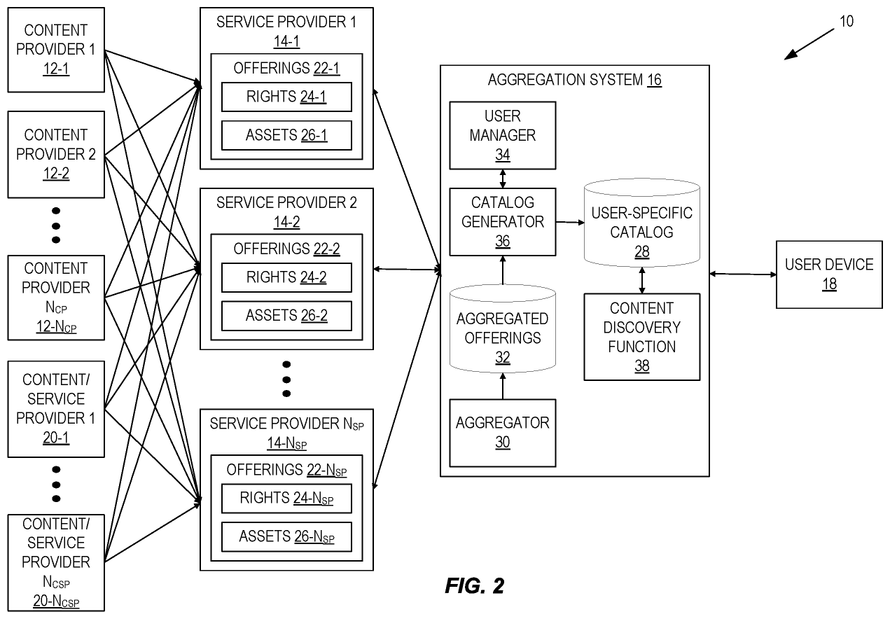

FIG. 2 is a more detailed illustration of the system 10 of FIG. 1 with respect to a single user device 18 according to some embodiments of the present disclosure. Note that while only one user device 18 is illustrated, the system 10 may include many user devices 18. As illustrated, the system 10 includes a number of content providers 12-1 through 12-N_{CP}, a number of content and service providers 20-1 through 20-N_{CSP}, a number of service providers 14-1 through 14-N_{SP}, the aggregation system 16, and the user device 18. The content and service providers 20-1 through 20-N_{CSP} are entities that are both content providers and service providers (e.g., HBO).

The service providers 14-1 through 14-N_{SP} provide a number of content offerings 22-1 through 22-N_{SP}. Notably, the content offerings provided by the service provider 14-1 are referenced as content offerings 22-1, the content offerings provided by the service provider 14-2 are referenced as content offerings 22-2, etc. Each content offering 22 includes content consumption rights 24 and an associated content asset(s) 26. The content consumption rights 24 define the terms under which the respective content item is being offered by the service provider 14 (e.g., price, etc.). The content asset(s) 26 includes either the respective content item or a reference (e.g., a Uniform Resource Locator (URL)) to the respective content item, which may be stored in the respective service provider system or stored in some third-party system. The content asset(s) 26 may also include metadata describing the respective content item being offered (e.g., title, date of release, poster art, etc.).

The aggregation system 16 may be client-based where the aggregation system 16 and resulting user-specific content catalog 28 are implemented within a client device (e.g., the user device 18 or another device located within the end-user's home or premises). Alternatively, the aggregation system 16 may be network or cloud based where the aggregation system 16 and the resulting user-specific content catalog 28 are in within a network or “in the cloud” and are equivalent to a content discovery middleware from the client perspective (i.e., from the perspective of the user device 18).

As illustrated, the aggregation system 16 includes an aggregator 30 that operates to obtain and aggregate the content offerings 22 from the service providers 14 to provide aggregated content offerings 32. The aggregated content offerings 32 are, in some embodiments, a collection or aggregation of the content offerings 22 from all of the service providers 14. Note that, in some embodiments, the content consumptions rights 24 are predefined or pre-negotiated, in which case the content offerings 22 in the aggregated content offerings 32 include the content consumption rights 24. However, in other embodiments, the content consumption rights 24 may be subsequently defined (e.g., through active negotiation), in which case the content consumption rights 24 may not be included in the aggregated content offerings 32 or may only be included in the aggregated content offerings 32 once obtained.

In some embodiments, the aggregated content offerings 32 include a list(s) of all of the content offerings 22 from all of the service providers 14. However, in other embodiments, the aggregated content offerings 32 include an aggregate list of all content items offered by all of the service providers 14. Then, for each content item, the aggregated content offerings 32 may include a list of the content offerings 22 for that content item.

As discussed above, the content offerings 22 included in the aggregated content offerings 32 include the content asset(s) 26 where the content asset(s) 26 include either a reference to the content item (e.g., a URL for accessing the content item via the respective service provider 14) or the actual content item (i.e., the digital file containing the content item). In some embodiments, since the same content item may be available from multiple service providers 14, the content items are preferably made available to the end-user(s) in a uniform manner in terms of packaging, codec, and Digital Rights Management (DRM)/encryption. In this regard, in order to provide uniformity, in some embodiments, the aggregated content offerings 32 include either:
A proxy or “handle” for each actual content item for each content offering 22, where the actual content item is stored in the service provider system(s) of the respective service provider(s) 14;
A logical copy (i.e., a binary or identical copy) of each content item for each content offering 22 stored locally;
A shared/common logical or actual copy of the content item for multiple service providers 14, i.e., if two or more service providers 14 provide the same content item, then a shared, or common, actual or logical copy of the content item is stored locally. For example, the shared or common copy may be a logical aggregation of the copies provided by the two or more service providers 14. A logical aggregation of the copies would be a single copy representing the copies of the various service providers 14, rather than multiple copies of the same content item.
A copy of each content item in a universal mezzanine format with Just-in-Time (JIT) packaging and encryption performed at playout. A mezzanine format is a common format that is used to bridge between a multitude of potential input and output formats.
Entitled for consumption on a per service provider and end-user basis. This is DRM entitlement, which has to be granted from the service provider 14 to the end user in order for the end user to consume (i.e., for the user device 18 to decode) the encrypted content.

A user manager 34 operates to obtain subscription rights of the end-user for any of the service providers 14 for which the end-user is a subscriber. A subscriber is a user that has a free or fee-based subscription to the service provided by a service provider 14. Some service providers 14 may allow guests to access content items. Guests have no ongoing or direct contractual relationship with the service provider 14. In this case, the aggregation system 16 may act as a temporary contractual proxy on behalf of the end-user and the service provider 14. Guests may be known to the service provider 14 or may be anonymous. In some embodiments, subscription rights may also depend on other aspects related to the end-user or the user device 18 such as, for example, device type(s) used for consumption (e.g., managed or OTT (i.e., Internet delivery)), current or provisioned geographic location, and/or promotional vouchers or codes.

In addition to obtaining the subscription rights of the end-user, the user manager 34 obtains offering acceptance preferences of the end-user associated with the user device 18. The end-user defines or otherwise selects what content consumption rights are acceptable to the end-user. As discussed herein, the offering acceptance preferences are used in order to determine the “best” content offering 22 for a particular content item in terms of, e.g.
purchase or rental price;
the maximum amount of advertisements present during consumption of the content item in accordance with the content offering;
the minimum playback quality (e.g., resolution, sound quality, etc.);
if a rental, the minimum rental duration;
portability (e.g., range of devices on which the content item can be consumed in accordance with the content offering);
whether the content item is downloadable or only streamable for the content offering;
preferred delivery method for streaming (e.g., Wi-Fi, cellular data, DTH satellite, cable, OTT, etc.); and
whether the content item for the content offering needs to be immediately available for streaming or if the end-user is willing to wait, e.g., for a defined period of time.

A catalog generator 36 operates to generate the user-specific content catalog 28 of content offerings available to the end-user from the service providers 14, e.g., based on the subscriptions of the end-user. Within the user-specific content catalog 28, there are content offerings 22 for many content items. Further, there may be multiple content offerings 22 for the same content item. In addition, in some embodiments, the catalog generator 36 pre-emptively identifies the best content offering for all of the content items in the user-specific content catalog 28 based on the content consumption rights 24 of the content offerings 22 for the content items and the offering acceptance preferences of the end-user. The “best” content offering for a particular content item is the content offering for that content item that mostly closely satisfies the offering acceptance preferences of the end-user. In other embodiments, the catalog generator 36 reactively identifies the best content offering for a particular content item upon selection of that content item by the end-user.

As discussed below in detail, in some embodiments, the catalog generator 36 actively negotiates the content consumption rights 24 for the content items in the user-specific content catalog 28. In other embodiments, the content consumption rights 24 are predefined by, e.g., the service provider 14, in which case the content consumption rights 24 are obtained by the aggregator 30 and included in the aggregated content offerings 32.

A content discovery function 38 enables the end-user at the user device 18 to discover a content item of interest from the end-user's user-specific content catalog 28. Any suitable discovery mechanism may be used. For example, the content discovery function 38 may enable the end-user, through the user device 18, to browse or search the user-specific content catalog 28 to select a content item for playback. Upon receiving the selection of a content item, the content discovery function 38 returns a best content offering to the user device 18. When returning the best content offering, the content discovery function 38 may return only the best content offering or may return a list of content offerings including the best content offering where the best content offering is indicated in the list. For example, the list may be a prioritized list of content offerings where the best content offering is given the highest priority. As discussed in more detail below, the best content offering may be identified by the catalog generator 36 pre-emptively (i.e., prior to receiving the selection of the content item) or reactively (i.e., upon receiving the selection of the content item). The end-user then selects the desired content offering. The user device 18 then requests the selected content offering. Upon receiving the request, the aggregation system 16 effects delivery of the selected content item in accordance with the requested content offering. Any suitable content delivery mechanism may be used. For example, in some embodiments, the aggregation system 16 initiates delivery of the content item from the respective service provider 14 to the user device 18 by, e.g., providing the appropriate URL to the user device 18. As another example, if the aggregation system 16 stores the media item, the aggregation system 16 delivers the media item to the user device 18.

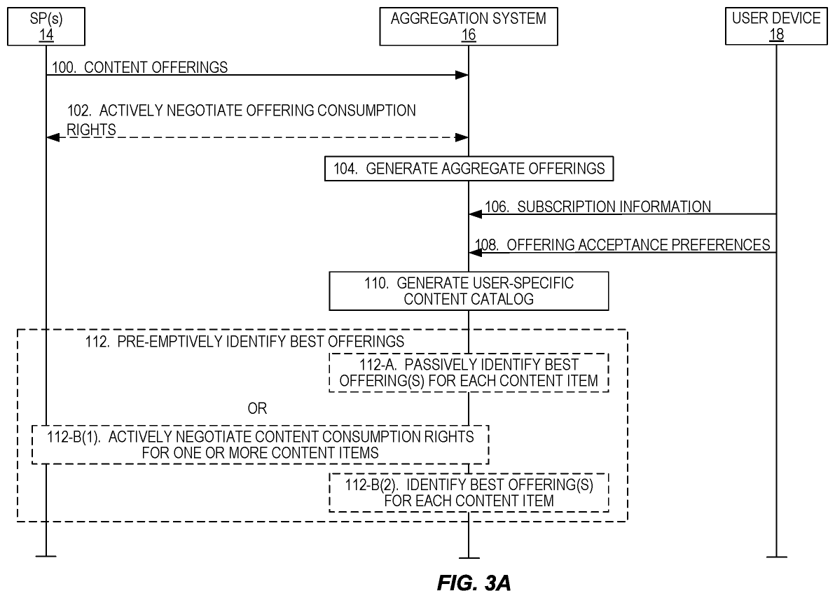

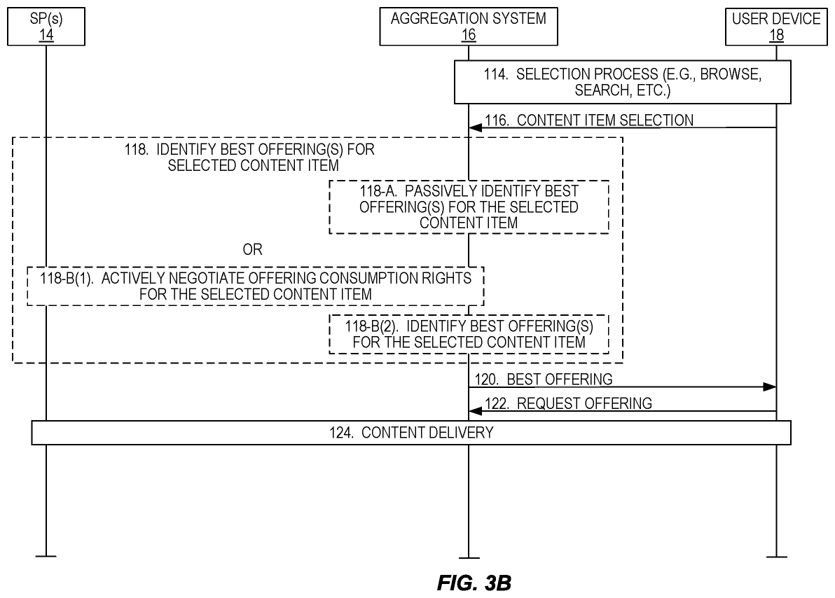

FIGS. 3A and 3B illustrate the operation of the system 10 of FIGS. 1 and 2 according to various embodiments of the present disclosure. Note that optional steps are illustrated with dashed lines. As illustrated, the aggregation system 16 obtains the content offerings 22 from the service providers 14 (step 100). The aggregation system 16 may obtain the content offerings 22 from the service providers 14 in any suitable manner. For example, in some embodiments, the aggregation system 16 sends a request to the respective service provider systems for the content offerings 22. The service provider systems then respond to the request with their content offerings 22. Note that, at this point, the content consumption rights 24 for the content offerings 22 may or may not yet be defined. For example, in some embodiments, the content offerings 22 do not yet include the content consumption rights 24, and the aggregation system 16 subsequently negotiates the content consumption rights 24 with the service providers 14 or the respective service provider systems. In another example, in some embodiments, the content offerings 22 include the content consumption rights 24, where these content consumption rights 24 may thereafter be modified via, e.g., active negotiation. In yet other embodiments, the content offerings 22 include the content consumption rights 24, where the content consumption rights 24 are static or can only be modified by the service providers 14. Note that the manner in which the content consumption rights 24 are defined and/or modified may vary among service providers 14 or even between content items from the same service provider 14.

In some embodiments, the aggregation system 16 actively negotiates with one or more of the service providers 14 to obtain or modify the content consumption rights 24 of one or more of the content offerings 22 (step 102). In some embodiments, the negotiation may be completely automated such that the negotiation is between the aggregation system 16 and the respective service provider systems. For example, the aggregation system 16 may agree to commit to purchasing or renting a defined number of copies of a particular content item in exchange for a reduced purchase or rental price.

Using the content offerings 22, the aggregation system 16 generates the aggregated content offerings 32, which may also be referred to herein as an aggregate catalog (step 104). As discussed above, the aggregate content offerings 32 are a collection or aggregation of all of the content offerings 22 from all of the service providers 14.

The aggregation system 16 also obtains subscription information from the user device 18 (step 106). The subscription information includes, for example, an indication of the service providers 14 for which the end-user is a subscriber and, if applicable, any credentials (e.g., username and password) needed to access the services provided by those service providers 14. Note that while the description here focuses on subscription-based service providers 14, the concepts are equally applicable to service providers 14 that provide free services. For example, for a free service provider 14 (e.g., a TV production company such as, e.g., NBC may provide a limited number of content items to users for free), the aggregation system 16 may obtain an indication from the user device 18 that the content offerings 22 are to include those from that service provider 14.

In addition, the aggregation system 16 obtains offering acceptance preferences from the user device 18 (step 108). As discussed above, the offering acceptance preferences may include, e.g., one or more of the following:
maximum purchase or rental price;
the maximum amount of advertisements present during consumption of the content item in accordance with the content offering;
the minimum playback quality (e.g., resolution, sound quality, etc.);
if a rental, the minimum rental duration;
portability (e.g., range of devices on which the content item can be consumed in accordance with the content offering);
whether the content item is downloadable or only streamable for the content offering;
preferred delivery method for streaming (e.g., Wi-Fi, cellular data, DTH satellite, cable, OTT, etc.); and
whether the content item for the content offering needs to be immediately available for streaming or if the end-user is willing to wait, e.g., for a defined period of time.
   Note that the end-user may additionally or alternatively be enabled to define or modify the offering acceptance preferences via another device (e.g., a smart phone).

The aggregation system 16 generates the user-specific content catalog 28 for the end-user based on, e.g., the subscription information (step 110). For example, the aggregation system 16 may filter the aggregated content offerings 32 to obtain only those content offerings 22 from the service providers 14 to which the end-user has access, e.g., as defined by the subscriber information. Thus, the user-specific content catalog 28 includes content offerings 22 for content items available to the end-user from the service providers 14 to which the end-user has access. Again, as described above, the user-specific content catalog 28 may include multiple content offerings 22 for the same content item, where these content offerings 22 may be from different service providers 14 and may have different content consumption rights 24.

In some embodiments, the aggregation system 16 pre-emptively identifies the best content offering for each content item for which the user-specific content catalog 28 includes at least one content offering (step 112). More specifically, for each content item for which the user-specific content catalog 28 includes one or more content offerings 22, the aggregation system 16 identifies the best content offering 22 for that content item based on the content consumption rights 24 for the one or more content offerings 22 for that content item and the offering acceptance preferences of the end-user. The best content offering 22 is the content offering 22 for the content item for which the content consumption rights 24 most closely satisfy the offer acceptance preferences of the end-user. Of course, for those content items for which there is only one content offering 22, that content offering can automatically be identified as the best content offering for that content offering without further analysis.

In some embodiments, pre-emptively identifying the best content offering for each content item in the user-specific content catalog 28 is done passively (step 112-A). In this context, passive, pre-emptively identifying of the best content offerings is passive in the sense that the content consumption rights 24 of the content offerings have previously been obtained by the aggregation system 16 (e.g., in step 100 or 102), and the aggregation system 16 does not take any further actions to obtain more favorable content consumption rights 24 in terms of the offering acceptance preferences of the end-user.

In other embodiments, pre-emptively identifying the best content offerings is done actively for all or at least some of the content items in the user-specific content catalog 28 of the end-user. More specifically, the aggregation system 16 actively negotiates, with the respective service providers 14, the content consumption rights 24 for the content offerings 22 for one or more, and potentially all, of the content items in the user-specific content catalog 28 (step 112-B(1)). For example, the aggregation system 16 may negotiate with the service providers 14, e.g., via the respective service provider systems, to secure the lowest price for the content item considering, e.g., the offer acceptance preferences of the end-user. Once negotiation is complete, the aggregation system 16 identifies the best content offering for each of the content items in the user-specific content catalog 28 considering the negotiated content consumption rights 24 and the offer acceptance preferences of the end-user (step 112-B(2)). For example, as discussed above, the best content offering 22 for a particular content item may be the content offering 22 having content consumption rights that most closely satisfy the offer acceptance preferences of the end-user. Note that if multiple content offerings 22 satisfy the offer acceptance preferences of the end-user, then the best content offering 22 may be, e.g., the one with the lowest price.

At some point, the aggregation system 16 and the user device 18 communicate to enable a selection process by which the end-user selects a desired content item from the user-specific content catalog 28 (step 114). The selection process may use any desired technique(s) to enable the end-user to select a desired content item. For example, the selection process may enable the end-user to search the user-specific content catalog 28 or browse the user-specific content catalog 28.

In some embodiments, the best content offerings 22 are not identified pre-emptively. Rather, upon receiving a content item selection (step 116), the aggregation system 16 reactively identifies the best content offering 22 for the selected content item (step 118). More specifically, the aggregation system 16 identifies the best content offering 22 for the selected content item based on the content consumption rights 24 for the one or more content offerings 22 for that content item and the offering acceptance preferences of the end-user. The best content offering 22 is the content offering 22 for the content item for which the content consumption rights 24 most closely satisfy the offer acceptance preferences of the end-user. Of course, if there is only one content offering 22 for the content item, then that content offering can automatically be identified as the best content offering for the content offering without further analysis.

In some embodiments, reactively identifying the best content offering for the selected content item in the user-specific content catalog 28 is done passively (step 118-A). In this context, passively, reactively identifying the best content offerings is passive in the sense that the content consumption rights 24 of the content offerings 22 for the selected content item have previously been obtained by the aggregation system 16 (e.g., in step 100 or 102), and the aggregation system 16 does not take any further actions to obtain more favorable content consumption rights 24 in terms of the offering acceptance preferences of the end-user.

In other embodiments, reactively identifying the best content offerings is done actively. More specifically, the aggregation system 16 actively negotiates, with the respective service providers 14, the content consumption rights 24 for the content offerings 22 for the selected content item (step 118-B(1)). For example, the aggregation system 16 may negotiate with the service providers 14, e.g., via the respective service provider systems, to secure the lowest price for the selected content item considering, e.g., the offer acceptance preferences of the end-user. As another example, the aggregation system 16 may request that the service providers 14 provide their offers for the selected content item based on the particular offer acceptance preferences of the end-user. Once negotiation is complete, the aggregation system 16 identifies the best content offering for the selected content item considering the negotiated content consumption rights 24 and the offer acceptance preferences of the end-user (step 118-B(2)). For example, as discussed above, the best content offering 22 for the selected content item may be the content offering 22 having content consumption rights that most closely satisfy the offer acceptance preferences of the end-user. Note that if multiple content offerings 22 satisfy the offer acceptance preferences of the end-user, then the best content offering 22 may be, e.g., the one with the lowest price.

The aggregation system 16 returns the best content offering 22 for the selected content item to the user device 18 (step 120). In some embodiments, the aggregation system 16 returns only the best content offering (i.e., does not return any other content offerings 22 for the selected content item). However, in other embodiments, the aggregation system 16 returns the best content offering and, if available, at least one of the other content offerings 22 for the selected content item. For example, the aggregation system 16 may return a prioritized list of content offerings 22 where the best content offering has the highest priority. The other content offerings may be prioritized in accordance with how closely the respective content consumption preferences 24 satisfy the offer acceptance preferences of the end-user.

The user device 18 then sends a request for, in this example, the best content offering of the selected content item (step 122). Upon receiving the request, the aggregation system 16 effects delivery of the selected content item e.g., from the service provider system of the service provider 14 providing the requested content offering 22 (step 124). The content item can be delivered from the service provider system to the user device 18 using any suitable content delivery mechanism.

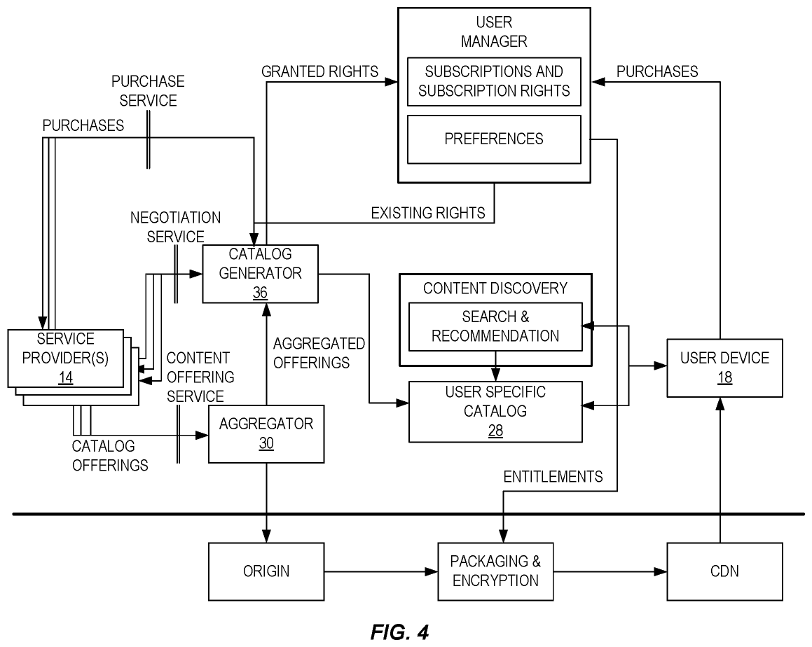

FIG. 4 illustrates the system 10 of FIGS. 1 and 2, but further illustrates various services, or interfaces, between the various components to enable aspects of some embodiments of the present disclosure. As illustrated, there is a content offering service between the service providers 14 and the aggregator 30 through which the aggregator 30 obtains the content offerings 22 from the service providers 14. A negotiation service enables the catalog generator 36 to, in some embodiments, negotiate the content consumption rights 24 for one or more of the content offerings 22 with one or more of the service providers 14. A purchase service enables the catalog generator 36 to purchase content items from the service providers 14 in accordance with the respective content offerings 22. Once the end-user purchases (or rents) a content item in accordance with a respective content offering 22, the proper entitlements are granted such that the content item is delivered to the user device 18 of the end-user via a Content Delivery Network (CDN). In particular, in this example, the content item originates from a source, which may be the service provider system, and is packaged and encrypted. The packaged and encrypted content item is then delivered to the user device 18 via the CDN.

The following Use Scenarios (USs) illustrate several example embodiments of the present disclosure. In particular, the following USs are described:
For passive identification of the best content offering(s):
   US1.1: User Browses and Choses Content
   US1.2: Pre-emptive Identification of the Best Content Offerings
For active identification of the best content offering(s):
   US2: User Browses and Choses Content
   US3: Aggregation System Bulk Purchases Content Items in accordance with Content Offerings
   US4: Content Provider Promotes Content Item(s) with, e.g., a Campaign Contract
      Note that US3 and US4 are only supported for network based implementations of the aggregation system 16.

### US1.1 User Browses and Choses Content (Passive Identification of Best Content Offerings)

In this US, the end-user has a subscription or otherwise has access to the aggregation system 16. Further, the subscription rights of the end-user are registered with the aggregation system 16, and the end-user has defined his or her offering acceptance preferences.

In operation, the followings steps are performed, as described above.
1. The aggregation system 16 generates the user-specific content catalog 28 of the end-user. In order to generate the user-specific content catalog 28 for the end-user, the aggregation system 16 retrieves all available content offerings 22 from the aggregated content offerings 32 and excludes the content offerings 22 that are not available to the end-user based on the subscription rights of the end-user versus the content consumption rights of the content offerings 22. Note that the content consumption rights 24 may indicate that the content offering 22 is only available to subscribers of the respective service provider 14. The available content offerings 22 are then used to populate the user-specific content catalog 28 for the end-user.
2. The end-user selects a particular content item from the content items in the user-specific content catalog 28 of the end-user. The content item may be selected from the user-specific content catalog 28 via, e.g. the output of a recommendation engine, search results, or browsing of the user-specific content catalog 28 (e.g., browsing by category).
3. The aggregation system 16 returns the best content offering 22, and potentially one or more additional content offerings 22, for the selected content item to the user device 18. The user device 18 presents the returned content offering(s) 22 to the end-user. As discussed above, in some embodiments, the aggregation system 16 determines the content offering 22 for the selected content item that has the lowest price and satisfies the offering acceptance preferences of the end-user. In some embodiments, the aggregation system 16 presents, via the user device 18, the best content offering and, potentially, one or more additional content offerings 22 for the selected content item to the end-user. If multiple content offerings 22 are presented, the content offerings 22 may be presented sorted in an order from lowest price to highest price, where the prices are presented to the end-user. In addition, additional details of the content offerings 22 may be presented (e.g., additional content consumption rights 24 such as, e.g., resolution, applicability of ads with an indication of how many ads can be expected (e.g., a star rating), how long the content offering 22 is available (e.g., rental period), how the respective content item can be delivered in terms of device types and delivery methods, when the content item for the content offering 22 will be broadcast (if it is linear content), any device playback restrictions, or the like).
4. The end-user accepts a desired one of the presented content offerings 22 (e.g., accepts the best content offering 22). Alternatively, the end-user could reject all of the presented content offerings 22.
5. The user device 18 sends a request for the accepted content offering 22 to the aggregation system 16. If a content offering 22 is accepted, the content item is purchased or rented, if applicable, in accordance with the content offering 22, where the end-user is charged for the purchase or rental. In some embodiments, the operator of the aggregation system 16 receives a portion of the purchase or rental price, and the remainder is passed to the respective service provider 14.
6. The content item is then entitled for consumption by the end-user and delivered to the user device 18 of the end-user for playback.

### US1.2: Pre-Emptive Identification of the Best Content Offerings

US1.2 is the same as US1.1, but in this variation, the best content offerings are identified pre-emptively when the user-specific content catalog 28 is generated rather than reactively upon receiving a content item selection from the user device 18. Otherwise, the process is the same as that described above for US1.1.

### US2 User Browses and Choses Content (Active Identification of Best Content Offerings)

US2 is the same as US1.1 but where, upon receiving the content item selection, the aggregation system 16 determines the content consumption rights (e.g., price) through active negotiation with the respective service providers 14. For example, the aggregation system 16 may share the prices for the content offerings 22 for the selected content item in the user-specific content catalog 28 with all of the service providers 14 offering the content item to the end-user to thereby negotiate the lowest possible price for the content item. For example, the service providers 14 may respond with updated content consumption rights 24 for their respective content offerings 22, where the updated content consumption rights 24 include, e.g., a lower price but, potentially, other varied content consumption rights (e.g., reduced rental duration, increased number of ads, or the like). This negotiation process can be repeated until either: none of the updated content offerings 22 satisfy the offering acceptance preferences of the end-user or none of the service providers 14 are willing to lower the price any further. As a variation, the offering acceptance preferences of the end-user can be shared with the service providers 14 as part of the negotiation process. The service providers 14 may (optionally) then respond with counter content offerings 22 that satisfy the offering acceptance preferences of the end-user. Note that negotiation could be based on any aspect of the content consumption rights (e.g., screen resolution), not just price.

### US3 Aggregation System Bulk Purchases Content Items in Accordance With Content Offerings (Active Identification of Best Content Offerings)

Independent to US1.1, US1.2, and US2, the aggregation system 16 may negotiate the pre-emptive purchase of multiple instances of a content offering 22 for future consumption by its own subscribers. This could be performed as part of a planned marketing campaign or promotion towards the subscribers of the aggregation system 16, possibly based on demand for a particular content item. Desired content consumption rights may be determined as part of marketing campaign plan.

The aggregation system 16 would specify how many instances of the content offering 22 that it wishes to purchase to each service provider 14, and optionally provide desired content consumption rights 24 for the content offering 22. The service providers 14 would then respond with their content offerings 22. The aggregation system 16 would then select the best content offering 22 (in terms of the desired content consumption rights) either passively or actively, and make the purchase.

The purchased content offerings 22 can then be included in the marketing campaign.

### US4 Content Provider Promotes Content Item(s) With, e.g., a Campaign Contract (Active Identification of Best Content Offerings)

Active Brokering: A content provider 12 promotes a content item(s) with campaign contract.

A marketing campaign is planned, whereby the aggregation system 16 or operator of the aggregation system 16 tenders a campaign contract towards the service providers 14 to sell a certain number of content offerings 22 over a pre-agreed time. The service providers 14 may accept or reject the contract.

If a service provider 14 accepts the contract, and the conditions of the contract are met by the aggregation system 16 or operator of the aggregation system 16, then a discount can be applied by the service provider 14. Typically, the condition would be that a discount would be applied as more of the content offerings 22 are sold by the aggregation system 16, either progressively or at certain sales thresholds. This discount could be applied either for all further sales, or applied retrospectively so past sales, with a refund/rebate being passed from the service providers 14 to the operator of the aggregation system 16. The discounted price may optionally be passed on to end-users, or a greater sale commission retained by the operator of the aggregation system 16.

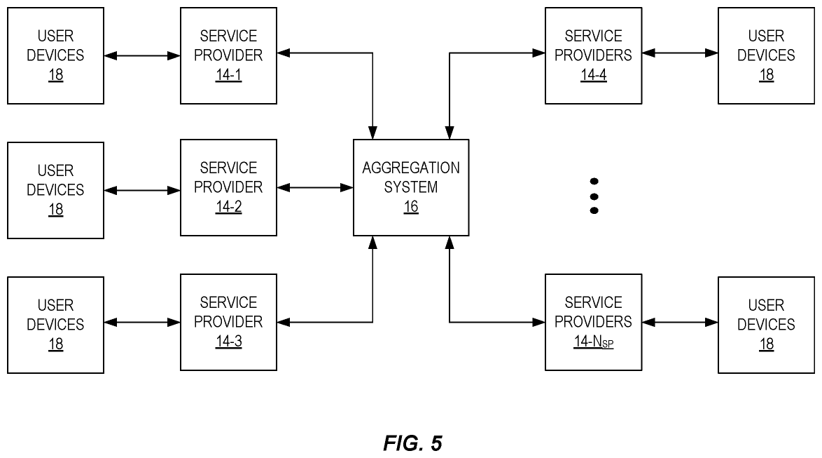

In the embodiments of FIGS. 1 and 2, the aggregation system 16 provides a unified service to end-users where, e.g., the end-users are subscribers to the service provided by the aggregation system 16. FIG. 5 illustrates an alternative embodiment of the system 10 in which the aggregation system 16 is implemented between the service providers 14. In this embodiment, each of the service providers 14, or more specifically the respective service provider systems, enable the end-user to select content items from the user-specific content catalog 28 generated by the aggregation system 16. In other words, the service providers 14, or more specifically the respective service provider systems, provide the interface between the user device 18 and the aggregation system 16.

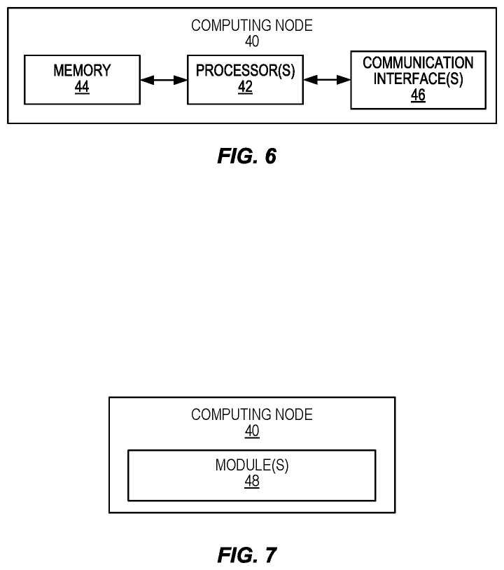

FIG. 6 illustrates a computing node 40 according to some embodiments of the present disclosure. The computing node 40 may be a processing node that implements the aggregation system 16, a node in a service provider system that provides functionality of a respective service provider 14, or a node in a content provider system that provides functionality of a respective content provider 12. As illustrated, the computing node 40 includes one or more processors 42 (e.g., CPUs, Application Specific Integrated Circuits (ASICs), Field Programmable Gate Arrays (FPGAs), and/or the like), memory 44, and a network interface 46. In some embodiments, the functionality of the aggregation system 16, a node in a service provider system that provides functionality of a respective service provider 14, or a node in a content provider system that provides functionality of a respective content provider 12 described above may be fully or partially implemented in software that is, e.g., stored in the memory 44 and executed by the processor(s) 42.

In some embodiments, a computer program including instructions which, when executed by at least one processor, causes the at least one processor to carry out the functionality of the computing node 40 according to any of the embodiments described herein is provided. In some embodiments, a carrier containing the aforementioned computer program product is provided. The carrier is one of an electronic signal, an optical signal, a radio signal, or a computer readable storage medium (e.g., a non-transitory computer readable medium such as memory).

FIG. 7 is a schematic block diagram of the computing node 40 according to some other embodiments of the present disclosure. The computing node 40 includes one or more modules 48, each of which is implemented in software. The module(s) 48 provide the functionality of the computing node 40 described herein. For example, for the aggregation system 16, the modules 48 may include a generating module 48 and an identifying module 48. The generating module 48 is operable to generate a user-specific content catalog comprising content offerings for a plurality of content items from two or more service providers 14 to which a respective user has access wherein, for each content item of the plurality of content items, the content offerings comprise at least one content offering for the content item from at least one of the two or more service providers 14. The identifying module 48 is operable to, for a content item of the plurality of content items, identify a best content offering from among the at least one content offering for the content item in accordance with one or more content consumption preferences associated with the respective user, the best content offering being a content offering from among the at least one content offering for the content item that most closely satisfies the one or more content consumption preferences associated with the respective user.

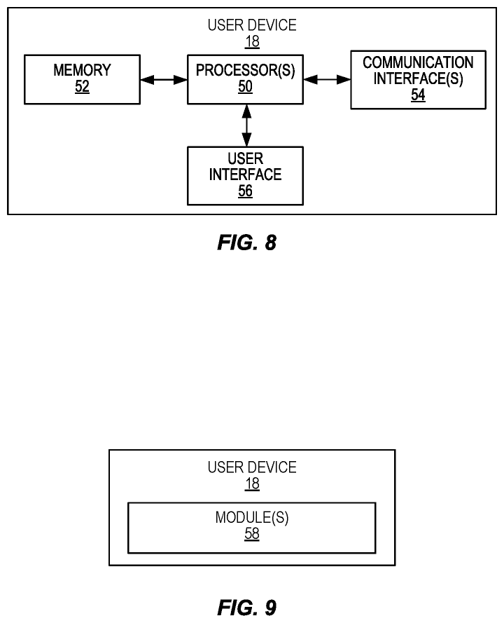

FIG. 8 is a schematic block diagram of the user device 18 according to some embodiments of the present disclosure. As illustrated, the wireless device 18 includes one or more processors 50 (e.g., CPUs, ASICs, FPGAs, and/or the like), memory 52, one or more communication interfaces 54 (e.g., cellular interface, Wireless Local Area Network (WLAN) interface, Ethernet interface, or the like), and a user interface 56 (e.g., a display, buttons, etc.). In some embodiments, the functionality of the user device 18 described above may be fully or partially implemented in software that is, e.g., stored in the memory 52 and executed by the processor(s) 50.

In some embodiments, a computer program including instructions which, when executed by at least one processor, causes the at least one processor to carry out the functionality of the user device 18 according to any of the embodiments described herein is provided. In some embodiments, a carrier containing the aforementioned computer program product is provided. The carrier is one of an electronic signal, an optical signal, a radio signal, or a computer readable storage medium (e.g., a non-transitory computer readable medium such as memory).

FIG. 9 is a schematic block diagram of the user device 18 according to some other embodiments of the present disclosure. The user device 18 includes one or more modules 58, each of which is implemented in software. The module(s) 58 provide the functionality of the user device 18 described herein. For example, in some embodiments, the modules 58 include:
a providing module 58 operable to provide a content item selection to the aggregation system 16,
a best content offering receiving module 58 operable to receive a best content offering for a content item indicated by the content item selection, the best content offering being a content offering from among at least one content offering for the content item that is available to a respective user of the user device 18 from two or more service providers 14 that most closely satisfies one or more content consumption preferences associated with the respective user of the user device 18,
a requesting module 58 operable to provide a request for the best content offering to the aggregation system 16, and
a content item receiving module 58 operable to receive the content item in accordance with the best content offering.

The following acronyms are used throughout this disclosure.
ASIC Application Specific Integrated Circuit
CDN Content Delivery Network
CPU Central Processing Unit
DRM Digital Rights Management
DTH Direct-to-Home
FPGA Field Programmable Gate Array
JIT Just-in-Time
OTT Over-the-Top
PPV Pay-Per-View
TV Television
URL Uniform Resource Locator
US Use Scenario
VoD Video On Demand
WLAN Wireless Local Area Network

Those skilled in the art will recognize improvements and modifications to the embodiments of the present disclosure. All such improvements and modifications are considered within the scope of the concepts disclosed herein and the claims that follow.

1. A method of operation of a computing node, comprising:
generating a user-specific content catalog comprising content offerings for a plurality of content items from two or more service providers to which a respective user has access, wherein, for each content item of the plurality of content items, the content offerings comprise at least one content offering for the content item from at least one of the two or more service providers; and
for a content item of the plurality of content items, identifying a best content offering from among the at least one content offering for the content item in accordance with one or more content consumption preferences associated with the respective user, the best content offering being a content offering from among the at least one content offering for the content item that most closely satisfies the one or more content consumption preferences associated with the respective user.

2. The method of claim 1 wherein the content offerings comprise multiple content offerings for a same content item, the multiple content offerings being from multiple respective service providers.

3. The method of claim 1 wherein identifying the best content offering from among the at least one content offering for the content item in accordance with the one or more content consumption preferences associated with the respective user comprises pre-emptively identifying the best content offering from among the at least one content offering for the content item.

4. The method of claim 3 further comprising:
for each additional content item of the plurality of content items in the user-specific content catalog, pre-emptively identifying a best content offering from among the at least one content offering for the additional content item in accordance with the one or more content consumption preferences associated with the respective user, the best content offering being a content offering from among the at least one content offering for the additional content item that most closely satisfies the one or more content consumption preferences associated with the respective user.

5. The method of claim 3 wherein pre-emptively identifying the best content offering from among the at least one content offering for the content item comprises pre-emptively identifying the best content offering from among the at least one content offering for the content item based on the one or more content consumption preferences associated with the respective user and content consumption rights previously obtained for the at least one content offering for the content item.

6. The method of claim 5 further comprising, prior to generating the user-specific content catalog, receiving the at least one content offering from the respective service provider, the at least one content offering comprising the content consumption rights for the at least one content offering for the content item.

7. The method of claim 5 further comprising, prior to generating the user-specific content catalog, actively negotiating the content consumption rights for the at least one content offering for the content item with at least one respective service provider.

8. The method of claim 3 wherein pre-emptively identifying the best content offering from among the at least one content offering for the content item comprises pre-emptively identifying the best content offering from among the at least one content offering for the content item based on the one or more content consumption preferences associated with the respective user and content consumption rights obtained for the content item in an active manner.

9. The method of claim 8 wherein pre-emptively identifying the best content offering from among the at least one content offering for the content item based on the one or more content consumption preferences associated with the respective user and the content consumption rights obtained for the content item in an active manner comprises:
after generating the user-specific content catalog, actively negotiating the content consumption rights for the at least one content offering for the content item with at least one respective service provider; and
identifying the best content offering from among the at least one content offering for the content item based on the one or more content consumption preferences associated with the respective user and the content consumption rights actively negotiated for the at least one content offering for the content item.

10. The method of claim 3 further comprising:
receiving a content item selection from a user device of the respective user, the content item selection being a selection of the content item for which the best content offering was pre-emptively identified; and
providing the best content offering identified for the content item to the user device.

11. The method of claim 10 further comprising:
receiving a request for the best content offering of the content item; and
upon receiving the request, effecting delivery of the content item from the respective service provider associated with the best content offering.

12. The method of claim 1 further comprising:
receiving a content item selection, the content item selection being a selection of one of the plurality of content items in the user-specific content catalog;
wherein identifying the best content offering from among the at least one content offering for the content item in accordance with the one or more content consumption preferences associated with the respective user comprises reactively identifying the best content offering from among the at least one content offering for the content item selected by the content item selection upon receiving the content item selection.

13. The method of claim 12 wherein reactively identifying the best content offering from among the at least one content offering for the content item comprises reactively identifying the best content offering from among the at least one content offering for the content item based on the one or more content consumption preferences associated with the respective user and content consumption rights previously obtained for the at least one content offering for the content item.

14. The method of claim 13 further comprising, prior to generating the user-specific content catalog, receiving the at least one content offering from the respective service provider, the at least one content offering comprising the content consumption rights for the at least one content offering for the content item.

15. The method of claim 13 further comprising, prior to generating the user-specific content catalog, actively negotiating the content consumption rights for the at least one content offering for the content item with at least one respective service provider.

16. The method of claim 12 wherein reactively identifying the best content offering from among the at least one content offering for the content item comprises reactively identifying the best content offering from among the at least one content offering for the content item based on the one or more content consumption preferences associated with the respective user and content consumption rights obtained for the content item in an active manner.

17. The method of claim 16 wherein reactively identifying the best content offering from among the at least one content offering for the content item based on the one or more content consumption preferences associated with the respective user and the content consumption rights obtained for the content item in an active manner comprises:
upon receiving the content item selection, actively negotiating the content consumption rights for the at least one content offering for the content item selected by the content item selection with at least one respective service provider; and
identifying the best content offering from among the at least one content offering for the content item selected by the content item selection based on the one or more content consumption preferences associated with the respective user and the content consumption rights actively negotiated for the at least one content offering for the content item selected by the content item selection.

18. The method of claim 12 further comprising:
providing the best content offering identified for the content item to a user device of the respective user.

19. The method of claim 18 further comprising:
receiving a request for the best content offering of the content item; and
upon receiving the request, effecting delivery of the content item from the respective service provider associated with the best content offering.

20. The method of claim 1 wherein identifying the best content offering from among the at least one content offering for the content item further comprises identifying the best content offering from among the at least one content offering for the content item in accordance with the one or more content consumption preferences associated with the respective user and subscription rights of the respective user.

21. The method of claim 1 wherein the one or more content consumption preferences associated with the respective user comprise at least one of a group consisting of:
a maximum purchase price;
a maximum rental price;
a minimum playback quality;
a minimum rental duration;
a preference related to portability;
a preferred delivery method;
a preference regarding immediate availability;
a preference for presence or absence of advertisements or commercials; and
a preference for a density of advertisements or commercials.

22. The method of claim 1 wherein at least one of the two or more service providers is a subscription-based service provider, and the respective user is a subscriber of the at least one of the two or more service providers.

23. The method of claim 1 wherein at least one of the two or more service providers is a subscription-based service provider, and the respective user is a guest of the at least one of the two or more service providers.

24. The method of claim 1 wherein at least one of the two or more service providers is a non-subscription-based service provider.

25. (canceled)

26. (canceled)

27. A computing node comprising:
at least one communication interface;
at least one processor; and
memory comprising instructions executable by the at least one processor whereby the computing node is operable to:
generate a user-specific content catalog comprising content offerings for a plurality of content items from two or more service providers to which a respective user has access, wherein, for each content item of the plurality of content items, the content offerings comprise at least one content offering for the content item from at least one of the two or more service providers; and
for a content item of the plurality of content items, identify a best content offering from among the at least one content offering for the content item in accordance with one or more content consumption preferences associated with the respective user, the best content offering being a content offering from among the at least one content offering for the content item that most closely satisfies the one or more content consumption preferences associated with the respective user.

28. (canceled)

29. A method of operation of a user device, comprising:
providing a content item selection to an aggregation system;
receiving a best content offering for a content item indicated by the content item selection, the best content offering being a content offering from among at least one content offering for the content item that is available to a respective user of the user device from two or more service providers that most closely satisfies one or more content consumption preferences associated with the respective user of the user device;
providing a request for the best content offering to the aggregation system; and
receiving the content item in accordance with the best content offering.

30. The method of claim 29 further comprising:
providing the one or more content consumption preferences to the aggregation system.

31. The method of claim 29 further comprising:
providing subscription information for the respective user to the aggregation system, the subscription information comprising information that is indicative of subscription rights of the respective user to one or more subscription-based service providers.

32. The method of claim 31 wherein the best content offering from among the at least one content offering for the content item is further based on the subscription rights of the respective user.

33. The method of claim 29 wherein the one or more content consumption preferences associated with the respective user comprise at least one of a group consisting of:
a maximum purchase price;
a maximum rental price;
a minimum playback quality;
a minimum rental duration;
a preference related to portability;
a preferred delivery method;
a preference regarding immediate availability;
a preference for presence or absence of advertisements or commercials; and
a preference for a density of advertisements or commercials.

34. The method of claim 29 wherein at least one of the two or more service providers is a subscription-based service provider, and the respective user is a subscriber of the at least one of the two or more service providers.

35. The method of claim 29 wherein at least one of the two or more service providers is a subscription-based service provider, and the respective user is a guest of the at least one of the two or more service providers.

36. The method of claim 29 wherein at least one of the two or more service providers is a non-subscription-based service provider.

37. (canceled)

38. (canceled)

39. A user device comprising:
at least one communication interface;
at least one processor; and
memory comprising instructions executable by the at least one processor whereby the user device is operable to:
provide a content item selection to an aggregation system;
receive a best content offering for a content item indicated by the content item selection, the best content offering being a content offering from among at least one content offering for the content item that is available to a respective user of the user device from two or more service providers that most closely satisfies one or more content consumption preferences associated with the respective user of the user device;
provide a request for the best content offering to the aggregation system; and
receive the content item in accordance with the best content offering.

40. (canceled)
